(19) United States
(12) Patent Application Publication
(10) Pub. No.: US 2009/0134719 A1
(43) Pub. Date: May 28, 2009

(54) ELECTRIC MOTOR CONTAINING FERROMAGNETIC PARTICLES

(75) Inventor: Richard R. Tomsic, Redondo Beach, CA (US)

Correspondence Address: STEFAN KIRCHANSKI, VENABLE LLP 2049 CENTURY PARK EAST, 21ST FLOOR, LOS ANGELES, CA, 90067, US

(73) Assignee: CIIIS, LLC, El Segundo, CA (US)

(21) Appl. No.: 12/297,193

(22) PCT Filed: Apr. 13, 2007
(86) PCT No.: PCT/US07/09048

§ 371 Date: Dec. 19, 2008

Related U.S. Application Data
(63) Continuation-in-part of application No. PCT/US06/19541, filed on May 22, 2006.
(60) Provisional application No. 60/744,907, filed on Apr. 14, 2006.

(51) Int. Cl. H02K 57/00; H02K 15/12

(52) U.S. Cl. 310/11; 310/45; 977/838

(57) ABSTRACT

An electric motor comprises a first member having one or more magnetic, electric or electro-magnetic components, a second member having one or more magnetic, electric or electro-magnetic components, and a fluid containing ferromagnetic particles located in between the first member and the second member.

### CROSS-REFERENCE TO RELATED APPLICATIONS

This application claims to U.S. Provisional Application No. 60/744,907, filed Apr. 13, 2006, and entitled “Electric Motor Torque Enhancement Using Ferro-Fluid.” The foregoing provisional application, as well as each other patent application and/or patent document recited below, are hereby incorporated by reference in their entirety to the extent permitted by law.

### FIELD OF INVENTION

The present invention generally relates to the fields of electric motors and generators. More particularly, the invention generally relates to maximizing electric motor performance properties, where stall torque has been shown to be improved, and thus since a motor's stall torque is an indication of the balance of the operational properties of the motor, improved performance of the motor in general is expected Similar performance improvements are expected in generators as well.

### BACKGROUND

Known electric motors convert electrical energy into mechanical energy while known electric generators convert mechanical energy into electrical energy. Although the below discussion centers on electric motors, a person having ordinary skill in the art will recognized its applicability to electric generators. Most electric motors work by electromagnetism. Magnetism is one of the phenomena by which materials exert an attractive or repulsive force on other materials. Some well known materials that exhibit easily detectable magnetic properties are nickel, iron, some steels, and the mineral magnetite; however, all materials are influenced to greater or lesser degree by the presence of a magnetic field.

Electromagnetism is the physics of the electromagnetic field; a field encompassing all of space which exerts a force on particles that possess the property of electric charge, and is in turn affected by the presence and motion of those particles. The magnetic field is produced by the motion of electric charges, i.e. electric current. The magnetic field causes the magnetic force associated with magnetism and/or magnets. Some magnets comprise materials that produce a magnetic field of their own. Permanent magnets occur naturally in some rocks, particularly lodestone, but they are now more commonly manufactured.

Ferromagnetism is a form of magnetism, as exhibited for example, in horseshoe magnets and refrigerator magnets. Ferromagnetism is defined as the phenomenon by which materials, such as iron, in an external magnetic field become magnetized and remain magnetized for a period after the material is no longer in the field. All permanent magnets are either ferromagnetic or ferromagnetic, as are the metals that are noticeably attracted to them.

Ferrofluid is a liquid possessing large magnetic susceptibility, which becomes strongly polarized in the presence of a magnetic field. Ferrofluids display paramagnetic properties in that they do not retain magnetization in the absence of an externally applied magnetic field. Ferrofluids are composed of nanoscale ferromagnetic particles suspended in a carrier fluid, usually an organic solvent or water. Often, the ferromagnetic nano-particles are coated with a surfactant to prevent their agglomeration (due to van der Waals and magnetic forces).

The fundamental principle upon which electromagnetic motors are based is that there is a mechanical force on any current-carrying wire contained within a magnetic field. The force is described by the Lorentz force law and is perpendicular to both the wire and the magnetic field. Most magnetic motors are rotary, but linear motors also exist. A rotary motor has a rotating member (usually on the inside) called the rotor and a stationary member called the stator. The rotor rotates about an axis because the current carrying wires and magnetic field are arranged so that a torque is developed about the rotor's axis. A linear motor is essentially an electric motor that has had its stator and rotor “unrolled” so that instead of producing a torque (rotation), it produces a linear force along its length. The most common mode of operation is as a Lorenz-type actuator, in which the applied force is linearly proportional to the current and the magnetic field.

As stated above, the fundamental principle upon which electromagnetic motors are based is that mechanical force is generated on any conductor conducting electricity within a magnetic field. The force is described by the Lorentz force law, and is given by:

F=qE+qv×B,

where F is the force vector, q is the electric charge, E is the electric field, v is the velocity vector of the electric charge, and B is the magnetic field vector. In linear and rotary motors, the force F moves a rotor in response to a magnetic field.

FIG. 1. shows a known rotary electric motor 10 that rotates at a rotational speed about a rotational axis 4 (e.g., shaft). The stator member of the motor is formed of permanent magnets 1 and the rotor member is formed by two rotor prongs 2 wrapped with coils 3. The rotor member rotates about the rotation axis 4 upon application of current to the coils 3, which create a magnetic field in the rotor prongs 2. Once the coils are energized, the magnetic field in the rotor prongs 2 interacts, in a well known manner, with the permanent magnetic fields of the permanent magnets 1 through a combination of attractive and repulsive forces. The result is a rotational force 5 about the rotational axis 4 having a corresponding torque measure. The created rotational force 5 rotates the rotor. As the magnetic field, created in the rotor, begins to align with the permanent magnetic field, the current flow in the rotor coils is reversed, starting the process over again. (For simplicity, the moving part of the electric motor is referred to as a rotor member throughout this application, even though linear motors do not have an element that rotates about its axis).

Electric motors are used in a wide variety of applications ranging from household appliances to industrial machines. One measure of performance for electric motors is efficiency in conversion of electric power or energy to mechanical power or energy. The efficiency of conventional electric motors can range from around 30%, for small universal electric motors, to around 90%, for three phase AC motors. One indication of overall efficiency for a given electric motor is its absolute stall torque. However, in order to optimize the absolute stall torque of the motor, other running aspects may have to be sacrificed. An example of an operational attribute which may have to be sacrificed to optimize the absolute stall torque is the ability to operate at high speeds. As the cost of electrical energy continues to rise, there exists a need to make electric motors more efficient. In addition, electric motors—particularly miniature linear motors are used in a variety of devices such as digital cameras where they provide motive forces to often tiny mechanical structures. In such miniature applications it is often important to provide the necessary mechanical power with minimum size and weight. Thus, there also exists a recognized need to reduce the size of electric motors while maximizing their delivered mechanical power.

### SUMMARY

Briefly, according to one aspect of the present invention, an electric motor comprises a first member having one or more magnetic components and a second member having one or more electric components with ferromagnetic particles, such as nano-particles, disposed on or in at least one of the first member and the second member. In one exemplary embodiment, the ferromagnetic particles are contained in a ferrofluid infused between the first and second members.

According to some of the more detailed features of this aspect of the invention, the electric motor comprises one of a linear motor, a DC motor, a universal motor, multi-phase AC motor, and induction motor. The first member comprises a stationary member and the second member comprises a non-stationary member. Alternatively, the first member can be a non-stationary member and the second member can be a stationary member. That is, the first member can be a stator and the second member can be a rotor and vice versa.

According to other more detailed features of this aspect of the invention, the ferromagnetic particles are disposed on the one or more electric components. In one exemplary embodiment, the ferromagnetic particles are fixed on the one or more electric components according to a desired orientation. The one or more electric components comprises at least one coil having conducting wire turns with air spaces between the turns, where the ferromagnetic particles are disposed within the air spaces of the coil. The coil can also have an insulating coating made of a high permeability material. For example, copper wire having an iron or ferrite coating.

According to another aspect of the invention, a method for maximizing the stall torque of an electric motor infuses a fluid containing ferromagnetic particles between the first member and second member and then removes the fluid, e.g., by force or through evaporation, such that the ferromagnetic particles remain disposed on at least one of the first member and the second member, e.g., the electric components.

### BRIEF DESCRIPTION OF THE DRAWINGS

Examples for some embodiments of the invention will be described with respect to the following drawings, in which like reference numerals represent like features throughout the figures, and in which:

FIG. 1 depicts an electric motor according to the Prior Art.

FIG. 2A-2C depict an exemplary embodiment of an electric motor according to the present invention.

FIG. 3 shows an experimental apparatus designed to test the functionality and efficiency of an electric motor.

FIG. 4 shows angular displacement chart for an electric motor infused with ferrofluid according to the present invention.

FIG. 5 shows angular displacement chart for a non-infused electric motor with ferrofluid.

FIG. 6 shows a comparison of the angular displacements of the infused and non-infused electric motors shown in FIGS. 4 and 5.

### DESCRIPTION OF THE INVENTION

The present invention involves an improvement to electric motor and generator design, which results in improved attractive and repulsive magnetic forces. The invention may improve an electric motor or generator's performance, namely by increasing torque output, for a motor or generator of a given size and weight. Although the present invention is discussed in relation to electric motors, a person having ordinary skill in the art will recognized its applicability to electric generators. According to one aspect of the present invention, a ferrofluid liquid is applied to an electric motor. In one exemplary embodiment, the ferrofluid is infused into the space between the rotor member and the stator member in an electric motor.

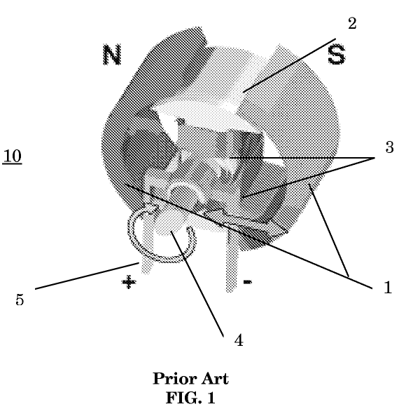

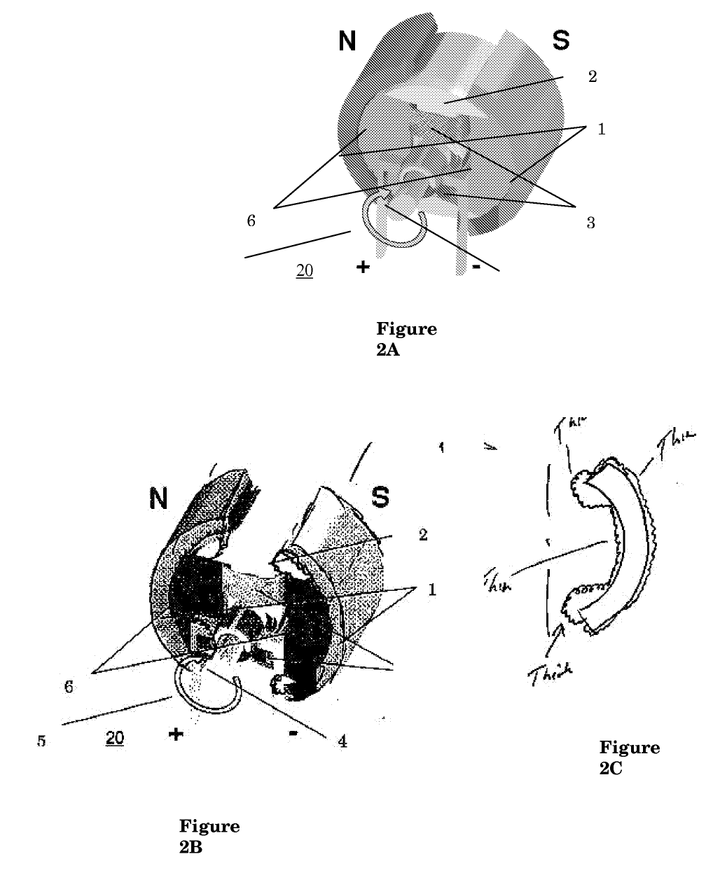

FIG. 2A-2C depict an electric motor 20 applied with a fluid containing ferromagnetic particles 6. Except for the application of the fluid containing ferromagnetic particles 6, the electric motor 20 is identical to the motor 10 shown in FIG. 1. As shown, the fluid containing ferromagnetic particles 6 is infused between the rotor member 2 and the stator member 1 of the electric motor 10 of FIG. 1. Fluid containing ferromagnetic particles 6 comprises nanoscale magnetic particles suspended in a carrier fluid. One example of fluid containing ferromagnetic particles 6 is ferrofluid. As is known, ferrofluid have very low hysterisis, and the solid particles of the ferrofluid do not agglomerate or phase separate, even in the presence of strong magnetic fields.

When the motor is not energized, the infused ferrofluid will move toward areas containing the highest magnetic flux density. Because the motor is not energized the ferrofluid rushes to the only areas of flux density, the poles of the permanent magnet in the stator member 1. When the motor becomes energized, some, but not all, of the ferrofluid will become attracted to the poles of the rotor 2, created when the coils 3 are energized. As the rotor rotates the ferrofluid attracted to the poles of the permanent magnet and the ferrofluid attracted to the poles of the rotor 2 come into contact and form a ferrofluid bridge as shown in FIG. 2B. FIG. 2C is a cross sectional view of a stator member 1 depicting the created thin and thick layers of the ferrofluid bridge when the ferrofluid pools to the outer poles of the permanent magnet. An adequate amount of ferrofluid is provided in the motor to facilitate the ferrofluid bridge as well as its pooling properties.

By creating a ferrofluid bridge in the space between the motor's rotor and stator members, there is an increase in the permeability of what is commonly referred to as the “Air Gap.” The “Air Gap” is the required gap between the outer surface of the rotor and the inner surface of the stator. The increased permeability results in greater attractive and repulsive forces between the magnetic field created by the stator member and the magnetic field created by the rotor member. Because the ferrofluid is not an electrical conductor, there is no danger the ferrofluid will result in a short circuit or have losses due to eddy currents. As a result, motors infused with ferrofluids according to the present invention generate a greater torque per load, in a rotary motor, and greater linear force per load, for a linear motor. The improvement can be utilized by any type of electric motors, including: linear motors, DC motors, universal motors, multi-phase AC motors, and induction motors.

Accordingly, an electric motor according to an exemplary embodiment of the invention, for example, a linear motor, DC motor, universal motor, multi-phase AC motor or induction motor comprises a first member having one or more magnetic components, e.g., permanent magnets, and a second member having one or more electric components, e.g., wires or coils 3. A fluid containing ferromagnetic particles, such nano-particles, is disposed between the first member and the second member of the electric motor to maximize the stall torque by enhancing the forces of attraction and repulsion. Within the motor, the first member can be a stationary member such as a stator, and the second member can be a non-stationary member, such as a rotor. Alternatively, the first member can be a non-stationary member with one or more magnetic components, and the second member can be a stationary member with one or more electric components.

In another exemplary embodiment of the invention, a method increases the stall torque of an electric motor by infusing or otherwise disposing a fluid containing ferromagnetic particles between a stationary member and a non-stationary member of the electric motor. Such infusing can be done by infiltrating or otherwise penetrating, depositing or dispersing the fluid between the stationary member and non-stationary member of the electric motor

Accordingly, the exemplary embodiments of the invention, described above, improve the performance of electric motors through infusion of ferrofluid. The advantage of this approach is that the performance of electric motors can be significantly improved without a substantial alteration to their design or fabrication.

According to another exemplary embodiment of the present invention, ferromagnetic particles are deposited or otherwise dispersed within the intricacies of the coils 3 of the rotor or stator. A coil 3 comprises a wound conducting wire with a thin insulating layer with a volume of air between the turns of the coil 3. This aspect of the present invention increase the magnet permeability of a coil 3 by infiltrating or otherwise penetrating, infusing, depositing, dispersing, or disposing particles having a high magnetic permeability within the air spaces of the coil 3. The insulating coating can also be made of material having high permeability.

In one exemplary embodiment, a fluid containing ferromagnetic particles is used for achieving such infiltration, penetration, infusion, depositing, dispersion or disposing. In one embodiment, the coil 3 is immerses in any evaporative carrier fluid, such as a ferrofluid, and force is applied (for example, mild centrifugation or evacuation) to facilitate infiltration. Once the fluid has evenly penetrated the coil's 3 intricacies the fluid can be evaporated to leave the nano-ferrite particles (approximately 5-10 nm in diameter) within the coil 3. In another embodiment, the ferromagnetic particles are suspended in super critical carbon dioxide fluid which can readily evaporate following infiltration.

In one embodiment, the ferromagnetic particles are fixed on the one or more electric components, e.g., the coil 3, according to a desired direction. The ferromagnetic particles can be oriented by exposure to magnetic fields for example via external magnets or by energizing the coil 3 with electricity during evaporation. In order to prevent movement or orientation of the ferromagnetic particles, a trace of a soluble resin can be added to the fluid containing ferromagnetic particles so that the ferromagnetic particles are “glued down.” Alternatively, a dense solution of ferromagnetic particles in a polymerizable matrix can be used so that after the coil 3 has been completely infiltrated, the matrix can be polymerized to leave the particles “frozen” in place. In either case, the orientation of the particles can be adjusted by applying an appropriate magnetic field before and during polymerization.

In another exemplary embodiment of the present invention, the spaces between the rotor member 2 and stator member 1, including the space between windings of the coils 3 are filled with nano-particles. Nano-particles may be placed into these spaces by infusing the electric motor with ferrofluid. After infusion, the carrier fluid is removed, for example, by evaporation, resulting in the deposition and filling of the spaces or coating of the rotor and stator with magnetic nano-particles. Thus, a method for depositing ferromagnetic particles within an electric motor that has a first member with one or more magnetic components and a second member with one or more electric components infuses the electric motor with a fluid containing ferromagnetic particles such that the ferromagnetic particles are deposited on at least one of the first member and the second member and removes the fluid such that the ferromagnetic particles remain deposited on at least one of the first member and the second member.

Accordingly, the present invention improves the performance of electric motors through infusion of ferromagnetic particles. In contrast, a similar improvement in attractive and repulsive forces within an electric motor can be achieved by adding more core material, assuming the design of the electric motor allows for the added volume. The present invention is therefore advantageous in that the performance of electric motors can be significantly improved without a substantial alteration to their design or fabrication.

Another aspect of infusing the motor with the ferrofluid is that of improved heat dissipation ability. Extreme service electric motors are driven to deliver high torque outputs in a relatively small size. In order to achieve this, the motor is supplied with high current levels to produce the high attractive and repulsive forces within the motor to deliver the high torque. The limitation for the service of the motor is when the internal conductors begin to heat up due to this high current (due to the inherent resistivity of the wire itself), until the wire and/or insulation is in danger of burning or melting. The most severe problem is within the rotor as the ability to transport the heat away from the rotor is limited. To mitigate this problem, heat transfer devices are sometimes incorporated within the motor to better flow this heat away from the rotor.

If the previously discussed example is made to be sealed, thus enclosing the ferrofluid within the chamber between the rotor and stator, the ferrofluid bridge inherent in its operation becomes a convenient heat flow path from the rotor to the stator, very similar to the operation of oil coolers in automobiles. With this arrangement and improved heat rejection ability, the motor could be made to accept higher current than otherwise possible, further increasing its ultimate capability. Thus for severe service electric motors, the dual benefit of the internal magnetic enhancements as well as the increased current handling capabilities can contribute jointly to allow increased torque capability of the motor.

Experimental Results Show Improved Motor Function After Infusion with Ferrofluid

Experiment results validate electrical functionality and stall torque of an electric motor with infused ferrofluid according to the present invention. An experimental apparatus designed to test such electric motor functionality and stall torque couples the drive shaft of a three prong, permanent magnet DC motor to an intermediate shaft connected to an anchored torsion spring, as shown in FIG. 3. The torsion spring exerts a torque on the shaft proportional to the angular displacement of the shaft, according to the following equation:

T=−kθ,

where T is torque exerted by the torsion spring, K is the torsion spring constant, and θ is the angular displacement of the shaft. As the electric motor exerts torque on the shaft, the shaft undergoes an angular displacement until the torque exerted by the electric motor is equal to the opposing torque exerted on the shaft by the spring. This point represents the maximum torque, or stall torque, exerted by the electric motor.

A diagram of the experimental apparatus is shown in FIG. 3. As shown, the stall torque is measured by the angular displacement of a torque reading pointer. Initially, the experiment uses a three prong, permanent magnet DC electric motor without infused ferrofluid, i.e., non-infused motor, to measure the stall torque for a constant electric load. The experiment uses a constant voltage of 5.4 volts applied to a non-infused electric motor (i.e., one that does not have infused ferrofluid) as well as an infused electric motor (i.e., one that contains infused ferrofluid) to measure respective maximum and minimum stall torques, for comparison. In a starting angular displacement position for maximum torque generation, the magnetic field of the stator starts out perpendicular to the magnetic field created by the prongs. In a starting angular displacement position for minimum torque generation, the magnetic field of the stator starts out substantially aligned with the magnetic field created by the prongs.

The experiment first records the angular displacement of the pointer representing the maximum and minimum stall torque for the infused electric motor and then infuses the same electric motor with ferrofluid and records the corresponding angular displacement of the pointer representing the maximum and minimum stall torque. Thus, the same experimental procedure is used for determining the maximum and minimum stall torques for the non-infused and infused electric motor.

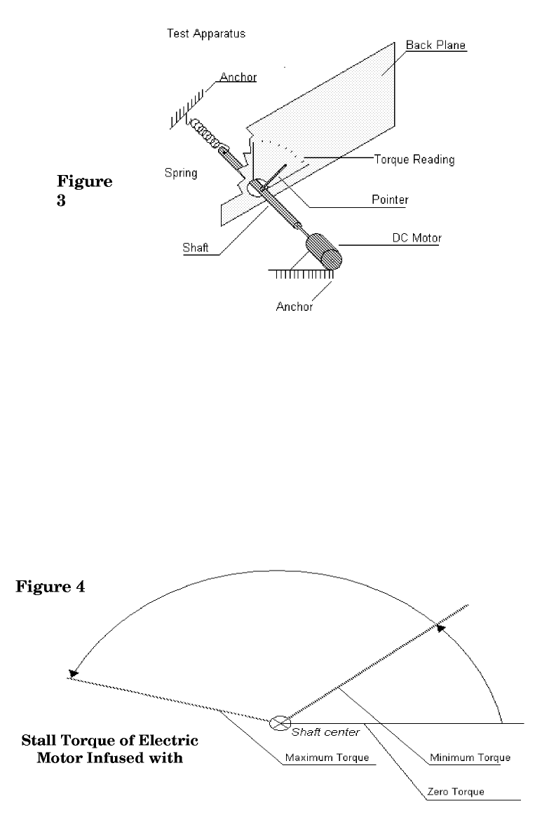

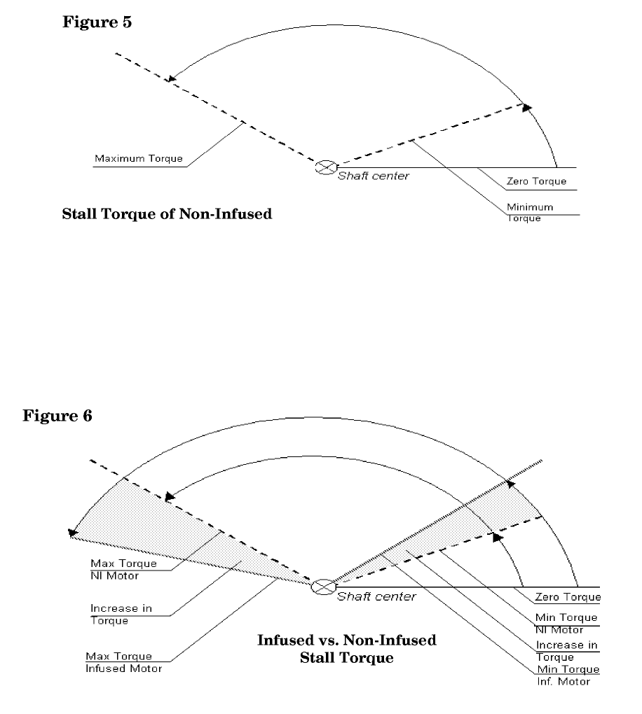

The results of the experiment show that for the same electric load, the maximum and minimum stall torque of the infused electric motor is greater than the maximum and minimum stall torque of the non-infused electric motor. The maximum and minimum stall torque for the electric motor infused with ferrofluid is shown on the chart of angular displacement in FIG. 4. The maximum and minimum stall torque for the non-infused electric motor is shown on the chart of angular displacement in FIG. 5. A comparison of the angular displacements of the infused and non-infused electric motor is shown in FIG. 6.

In addition to the improved torque output of the electric motor, the experimental results also show that the stall torque of the electric motor is improved by the infusion of ferrofluid. The gain in torque output for a given, constant electric load suggests that there is an increase in the conversion of electrical/magnetic energy into mechanical energy. The controlled conditions of the experiment (i.e., the use of the same motor, and experimental apparatus) tend to negate the presence of any artifact that could lead to an illusory improvement in torque.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiments have been set forth only for the purposes of example and that should not be taken as limiting the invention. Therefore, it is to be understood that, within the scope of the appended claims, the invention may be practiced other than as specifically described herein.

1. An electric motor comprising:
a first member comprising one or more magnetic, electric, or electro-magnetic components;
a second member comprising one or more magnetic, electro-magnetic, or electric components; and
ferromagnetic particles disposed on or within at least one of the first member and the second member.

2. The electric motor of claim 1, wherein the ferromagnetic particles comprise nano-particles.

3. The electric motor of claim 1, wherein the ferromagnetic particles are contained in a ferrofluid infused between the first and second members.

4. The electric motor of claim 1, wherein the first member comprises a stationary member and the second member comprises a non-stationary member.

5. The electric motor of claim 1, wherein the first member comprises a non-stationary member and the second member comprises a stationary member.

6. The electric motor of claim 1, wherein the first member is a stator and the second member is a rotor.

7. The electric motor of claim 1, wherein the first member is a stator and the second member is a rotor.

8. The electric motor of claim 1, wherein the electric motor is one of a linear motor, a DC motor, a universal motor, a multi-phase AC motor, and an induction motor.

9. The electric motor of claim 1, wherein the ferromagnetic particles are disposed on the one or more electric components.

10. The electric motor of claim 1, wherein the one or more electric components comprises at least one coil having conducting wire turns with air spaces between the turns, and wherein the ferromagnetic particles are disposed within the air spaces of the coil.

11. The electric motor of claim 10, wherein the at least one coil has an insulating coating comprising a material having high magnetic permeability.

12. The electric motor of claim 1, wherein ferromagnetic particles are fixed on the one or more electric components according to a desired orientation.

13. A method for improving an electric motor having at least a first member comprising one or more magnetic, electric, or electro-magnetic components and a second member comprising one or more electric, electro-magnetic, or magnetic components comprising the steps of:
infusing a fluid containing ferromagnetic particles between the first member and second member; and
removing the fluid such that the ferromagnetic particles remain disposed on or within at least one of the first member and the second member.

14. The method of claim 13, wherein the fluid is removed through at least one of centrifugal force and evaporation.

15. The method of claim 13, wherein the ferromagnetic particles are disposed on the one or more electric components.

16. The method of claim 13, wherein the one or more electric components comprises at least one coil having conducting wire turns with air spaces between the turns, and wherein the ferromagnetic particles are disposed within the air spaces of the coil.

17. The method of claim 16, wherein the at least one coil has an insulating coating comprising a material having high magnetic permeability.

18. The method of claim 13, wherein ferromagnetic particles are fixed on the one or more electric components according to a desired orientation.

19. The method of claim 13, wherein the ferromagnetic particles comprise nano-particles.

20. An electric motor comprising:
a first member comprising one or more magnetic, electric, or electro-magnetic components;
a second member comprising one or more electric, electro-magnetic, or magnetic components; and
a fluid containing ferromagnetic particles disposed between the first member and second member.

21. A method for improving an electric motor having at least a first member comprising one or more magnetic, electric, or electro-magnetic components and a second member comprising one or more electric, electro-magnetic, or magnetic components comprising the step of infusing a fluid containing ferromagnetic particles between the first member and second member.

22. An electric motor having at least first member comprising one or more magnetic, electric, or electro-magnetic components and a second member comprising one or more electric, electro-magnetic, or magnetic components, wherein at least one of the first and the second member includes a coil formed from a conductor which has an insulating coating of a material with high magnetic permeability.

23. A method for improving an electric motor having at least a first member comprising one or more magnetic, electric, or electro-magnetic components and a second member comprising one or more electric, electro-magnetic, or magnetic components wherein at least one of the first and the second member includes a coil comprising the step of forming the coil from a conductor which has an insulating coating of a material with high magnetic permeability.
